(19) United States
(12) Patent Application Publication
(10) Pub. No.: US 2014/0356078 A1
(43) Pub. Date: Dec. 4, 2014

(54) Powder Flow Monitor and Method for In-flight Measurement of a Flow of Powder

(71) Applicant: TEKNA PLASMA SYSTEMS INC., Sherbrooke (CA)

(72) Inventors: Radoslaw STANOWSKI, Sherbrooke (CA); Maher BOULOS, Sherbrooke (CA)

(73) Assignee: TEKNA PLASMA SYSTEMS INC., Sherbrooke (CA)

(21) Appl. No.: 14/290,401

(22) Filed: May 29, 2014

Related U.S. Application Data
(60) Provisional application No. 61/829,456, filed on May 31, 2013.

(51) Int. Cl. B65G 53/66

(52) U.S. Cl. CPC B65G 53/66
USPC 406/36

(57) ABSTRACT

A powder flow monitor includes a powder transport tube, a sensor of a flow of powder in the powder transport tube, and an oscillator configured to impart a cleaning vibration to the powder transport tube. A method is for in-flight monitoring of a flow of powder using the powder flow monitor.

### TECHNICAL FIELD

The present disclosure relates to the field of powder flow measurements. More specifically, the present disclosure relates to a powder flow monitor and to a method for in-flight measurement of a flow of powder.

### BACKGROUND

In-flight monitoring of powder flows in pneumatic transfer operations or in the form of a solid suspension in a liquid has been of major concern over the past few decades. So far, most accurate monitoring techniques have been based on the use of light diffusion across a flow of the powder suspended into a gas or liquid stream. Alternate approaches have been used for the development of such devices. These make use of electrical property measurements, or mechanical force measurements obtained through the impact of the transported powder on a load-sensitive target.

FIG. 1 is a schematic representation of light scattering over transported particle surfaces. FIG. 1 shows a set-up 100 comprising a light source 105, a light-transparent transport tube 110 seen in cross-sectional view, a light detector 115, a beam of light 120 emitted from the light source 105 along an optical axis 125, diffracted and/or scattered light rays 130, a transmitted light fraction 135, powder particles 140 transported in a fluid 145, and powder particles 150 deposited on the inner surface of the tube 110. As illustrated in FIG. 1, the beam of light 120 traverses the light-transparent transport tube 110 in which the fluid 145 transporting the powder particles 140 is flowing. As light travels through the transport tube 110, some of the light is either obstructed by the powder particles 140, or diffracted 130 at the surface of the powder particles 140. The net transmitted light 135 passes unhindered across the flow of powder particles 140 and the fluid 145 emerges from the opposite side of the transport tube 110, reaching the light detector 115. As also illustrated in FIG. 1, some of the light 120 can be slightly deviated by the powder particle 140 but still reaches the light detector 115. The intensity of the transmitted light fraction 135 collected by the light detector 115 is a function of a volumetric fraction of the powder particles 140 in the fluid 145. As loading of the powder particles 140 increases in the fluid 145, the intensity of the transmitted light fraction 135 reaching the light detector 115 decreases. Therefore, the intensity of the transmitted light fraction 135 reflects the volumetric fraction of the powder particles 140 in the fluid 145.

Conventional devices based on in-flight monitoring of a flow of powder suffer from a number of drawbacks. In general, these devices are either not sufficiently reliable for quantitative powder flow monitoring, or suffer from drift with time due to powder deposition (see powder particles 150 in FIG. 1) on the inner surface of their powder transport tube.

The principal problem with this concept is that some of the transported particles 140 eventually deposit on the inner surface of the transport tube 110. Deposited powder particles 150 gradually obstruct the field of vision of the light detector 115, sometimes in a permanent way, and gradually decrease the intensity of the transmitted light fraction 135 reaching the light detector 115 for a given powder particle loading in the fluid 145. This phenomenon results in a gradual drift of the intensity of the transmitted light fraction 135 and, consequently, a corresponding drift of an apparent rate of flow of the powder particles 140. Systematic measurement errors are thus introduced. Drifting of a zero-reference level prevents obtaining reproducible operating conditions, compromising desired quality and feature uniformity of the final powder product.

The problem caused by deposited particles 150 is conventionally overcome by the intermittent stopping of operations of the set-up 100 for manual cleaning the inner surface of the transport tube 110, in order to restore its original condition. An alternate, conventional approach comprises removal of deposited powder particles 150 by injection of a stream of cleaning fluid over the inner surface of the transport tube 110.

These cleaning operations need to be repeated frequently in order to maintain accuracy of flow measurements. This requires extensive manpower, is time consuming, and causes significant downtime. Therefore, there is a need for in-flight powder flow monitoring techniques that are reliable, precise, and substantially free from drifting over time.

### SUMMARY

According to the present disclosure, there is provided a powder flow monitor. The device comprises a powder transport tube, a sensor of a flow of powder in the powder transport tube, and an oscillator configured to impart a cleaning vibration to the powder transport tube.

According to the present disclosure, there is also provided a method of in-flight monitoring of a flow of powder. A powder transport tube is provided. The flow of powder is produced in the powder transport tube. A feature of the flow of powder in the powder transport tube is detected. A cleaning vibration is imparted to the powder transport tube.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a schematic representation of light scattering over transported particle surfaces;

FIG. 2 is a front elevation, cross-sectional view of a powder flow monitor according to an embodiment;

FIG. 3 is a front elevation, cross-sectional view of an alternative to the powder flow monitor of FIG. 2;

FIG. 4 is a horizontal, cross-sectional view of a variant of the powder flow monitor having a pair of photodetectors;

FIG. 5 schematically illustrates a system and method for cooling piezoelectric actuators of the powder flow monitor of FIGS. 2-4;

FIG. 6 is perspective view of a variant of the powder flow monitor showing aeration grooves in a top section;

FIG. 7 is a sequence showing operations of a method for in-flight monitoring of a flow of powder according to an embodiment;

FIG. 8 is a graph showing powder flow measurements under various powder flow rates;

FIG. 9 is a graph showing details of the powder flow measurements of FIG. 8;

FIG. 10 is a graph showing powder flow measurements using a powder feed rate modulated according to a sinusoidal signal; and

FIG. 11 is graph showing powder flow measurements using a variable modulation of the powder feed rate.

Like numerals represent like features on the various drawings.

### DETAILED DESCRIPTION

Various aspects of the present disclosure generally address one or more of the problems related to the lack of reliability and to drift of conventional devices made for in-flight monitoring of a flow of powder, and to the need for frequent cleaning of such devices.

In one aspect, the present disclosure relates to a powder flow monitor for determining, in particular but not exclusively, a concentration and/or mass flow rate of transported solids, i.e. particles, suspended in a fluid. The powder flow monitor comprises a powder transport tube, a sensor of a flow rate of powder in the powder transport tube, and an oscillator that imparts a cleaning vibration to the powder transport tube.

In another aspect, the present disclosure introduces a powder flow monitor that combines an application of a Surface Acoustic Wave (SAW), or any other suitable type of mechanical vibrations surface wave to a light-transparent powder transport tube with use of scattered light diffusion phenomena for in-flight monitoring of a flow of powder transported in a gas or liquid stream. The SAW is applied either continuously or in a periodic repetitive fashion in order to maintain the inner surface of the transparent powder transport tube substantially free from any deposited powder. The wave propagates on the tube, including an inner surface of the tube. The effect of this wave application is that gradual powder-build up on the inner surface of the powder transport tube is eliminated. More specifically, application of a vibration in the form of the wave maintains the cleanliness of the inner surface of the powder transport tube by avoiding deposition of powder particles. As a result, drifting of powder flow measurements occurring in conventional devices using light scattering is also eliminated. The powder flow monitor allows precise, stable and reproducible monitoring of a flow of powder in the gas or liquid stream.

According to the present disclosure, the deposition of powder particles on the inner surface of the transport tube is prevented through the use of, for example, a Surface Acoustic Wave (SAW) applied to the upstream or top portion of the transport tube. The generated vibration applied to the tube propagates on the inner surface of the tube and prevents the deposition of any particles on the inner surface so that it remains clean and unobstructed over a long period of time. The vibration also causes homogenization of the flow of powder in the transport tube. A direct consequence of adding this vibration to the transport tube is the enhanced signal reproducibility and stability with time, with enhanced precision and dynamic range of the powder flow measurement.

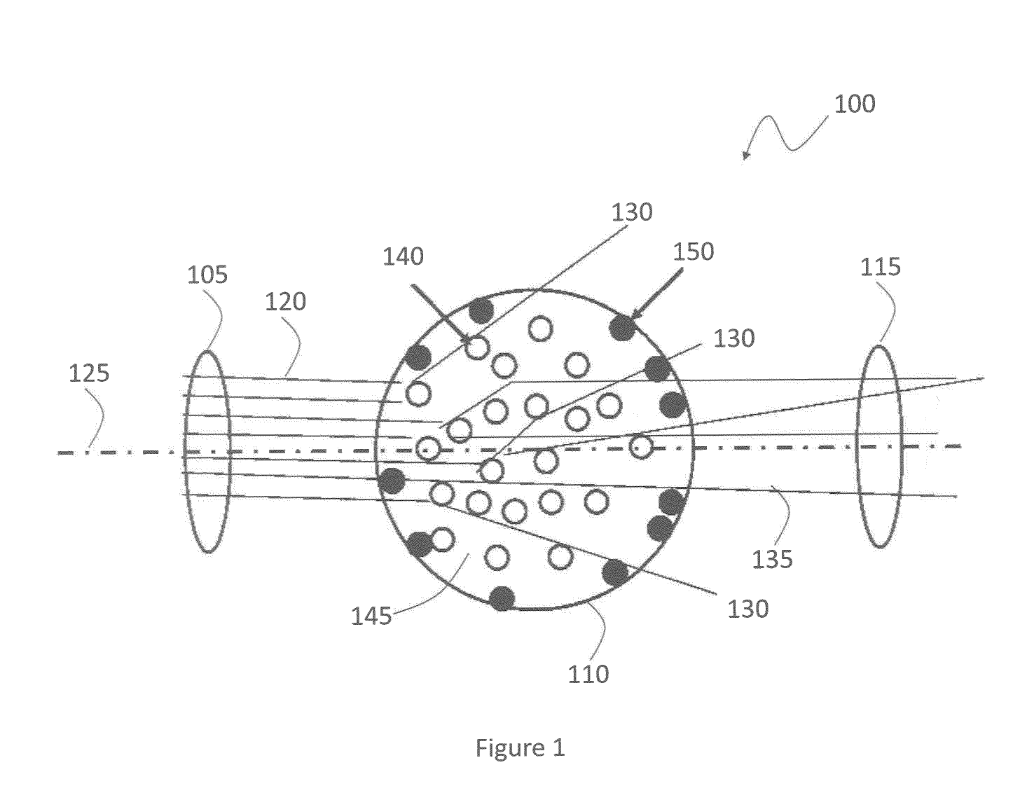

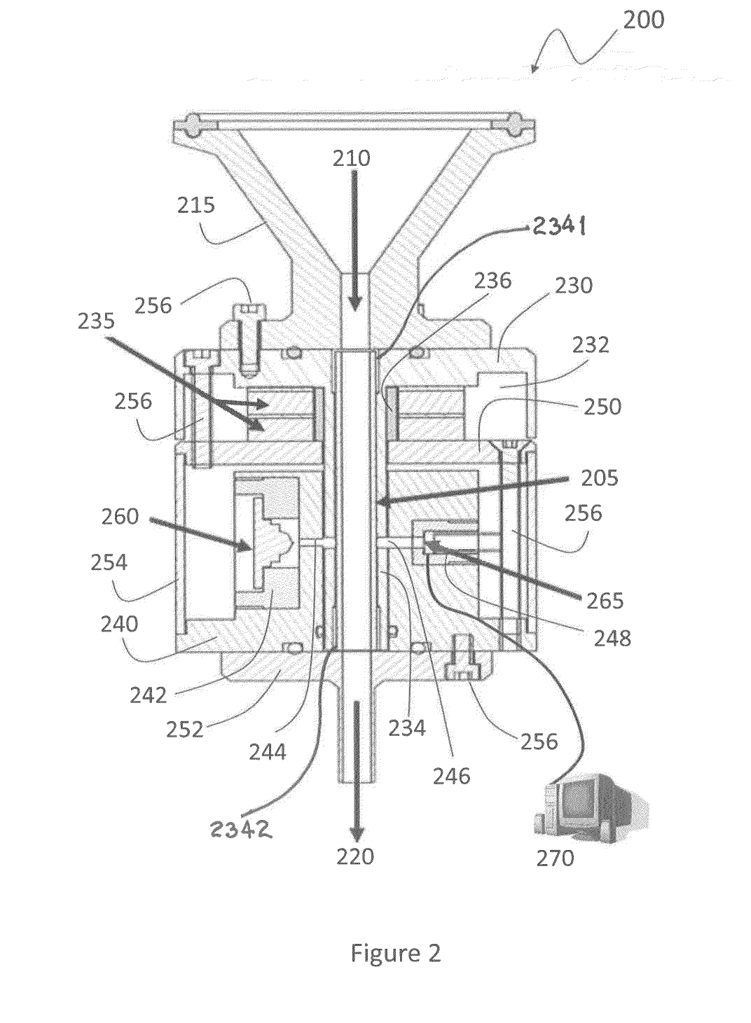

FIG. 2 is a front elevation, cross-sectional view of a powder flow monitor according to an embodiment. Referring FIG. 2, the powder flow monitor 200 comprises a light-transparent powder transport tube 205, for example a borosilicate light-transparent glass tube 205, used for transport of powder particles 140 (shown on FIG. 1) using an appropriate carrier gas or liquid 145 (shown on FIG. 1). Other materials that are immune to ultrasonic vibrations and to thermal charge generation, such as, without loss of generality, sapphire, can be selected for making the powder transport tube. Another alternative is a powder transport tube 205 made of non-transparent material, for example metal, ceramics or any other suitable material, provided with diametrically opposite windows (made for example of the above mentioned transparent materials) or optical fibers to allow the passage of light through the inside of the powder transport tube 205; according to this alternative, the powder transport tube 205 can even be formed by the tubular extension 234. The material of the powder transport tube 205 is selected so that it does not exhibit any piezoelectric effect that could lead to the electrostatic charging of the inner surface of the powder transport tube 205. The electric charge induced force could be greater for small diameter particles than the mechanical shear force induced by longitudinal and vertical SAW responsible for preventing deposition of the particles on the inner surface of the powder transport tube. The transported powder particles 140 and the fluid 145 enter the powder flow monitor 200 from its top 210 through a feeder adapter cone 215 and exits from an opposite lower end 220 of the powder flow monitor 200 to a powder transport line (not shown).

The feeder adapter cone 215 and the powder transport tube 205 are supported by a casing comprising a top section 230, a bottom section 240, a middle plate 250 that separates the top section 230 and the bottom section 240, a lower cover 252, and a cylindrical shield 254 encircling the bottom section 240. Various screws such as 256 are used to assemble these elements of the powder flow monitor 200.

The top section 230 forms an internal, annular cavity 232 and further comprises a central, tubular extension 234 that extends downwardly through the middle plate 250 and along a length of the bottom section 240. The tubular extension 234 is made of a hard material capable of transmitting the SAW; non-limiting examples include steel and aluminum. As illustrated, the tubular extension 234 forms a unitary piece with the top section 230. However, the tubular extension 234 may be a separate part, distinct from the top section 230, in which case the top section 230 may be made of the same or any other suitable material. The powder transport tube 205 is inserted within the tubular extension 234.

Two annular piezoelectric actuators 235 are located within the annular cavity 232, underneath the top section 230, and wrap around a short insulating cylinder 236 that itself wraps around an upper part of the tubular extension 234. The insulating cylinder 236 does not need to stay in permanent contact with the piezoelectric actuators 235 or with the tubular extension 234. It can be made from Teflon™ or from any equivalent non-conducting polymer.

The bottom section 240 comprises a support 242 for holding a light source 260, for example an optoelectronic light source such as a 3-watt white light-emitting diode (LED), to laterally illuminate the light-transparent powder transport tube 205. A laser source may also be used instead of the white LED. Light from the light source 260 reaches the tube 205 via an input channel 244 that extends within the bottom section 240 and through the tubular extension 234, forming an illumination window. Diffused and/or scattered light passing through the tube 205 (or the above described windows or optical fibers of this tube 205), is transmitted via a detection window formed by an output channel 246 created through the tubular extension 234 and within the bottom section 240. This light is monitored by a photodetector 265, for example a cadmium sulfide (CdS) photo-resistor, a photo-diode, an equivalent optoelectronic, semiconductor-based photodetector, a solar battery, or any other light sensor. In a particular aspect, the middle plate 250 and the circular shield 254 with bottom section 240 can form a Faraday cage that prevents electro-magnetic noise that could influence the light source 260 and the photodetector 265. The photodetector 265 is maintained in position within the bottom section 240 by a support 248. The circular shield 254 prevents contamination from external light within the powder flow monitor 200 and serves as an overall shield for the encapsulation of electronic circuits (not shown) used to power the light source 260 and the photodetector 265.

As shown on FIG. 2, the two annular piezoelectric actuators 235 are located upstream of and separate from the light source 260 and from the photodetector 265 on the tube 205. The two annular piezoelectric actuators 235 are supplied with an alternating current to produce a vibration applied to the powder transport tube 205. More specifically, the annular piezoelectric actuators 235 are used as an oscillator to produce and apply to the powder transport tube 205 a wave, such as a SAW, through the material of the top portion 230 and tubular extension 234, and through hard epoxy 2341 and 2342 securing the outer surface of upper and lower sections the powder transport tube 205 to the inner surface of upper and lower sections of the tubular extension 234. The wave, such as a SAW, propagating on the inner surface of the tube 205 reduces or substantially prevents any permanent deposition of the transported powder particles 140 on the inner surface of the tube 205. The wave, such as a SAW, may oscillate at ultrasonic frequencies. By reducing or substantially preventing any permanent deposition of the transported powder particles 140 on the inner surface of the tube 205, the wave, such as a SAW, enhances the stability with time of the intensity of the light transmission across the tube 205 in relation to the given powder particle 140 loading of the fluid 145.

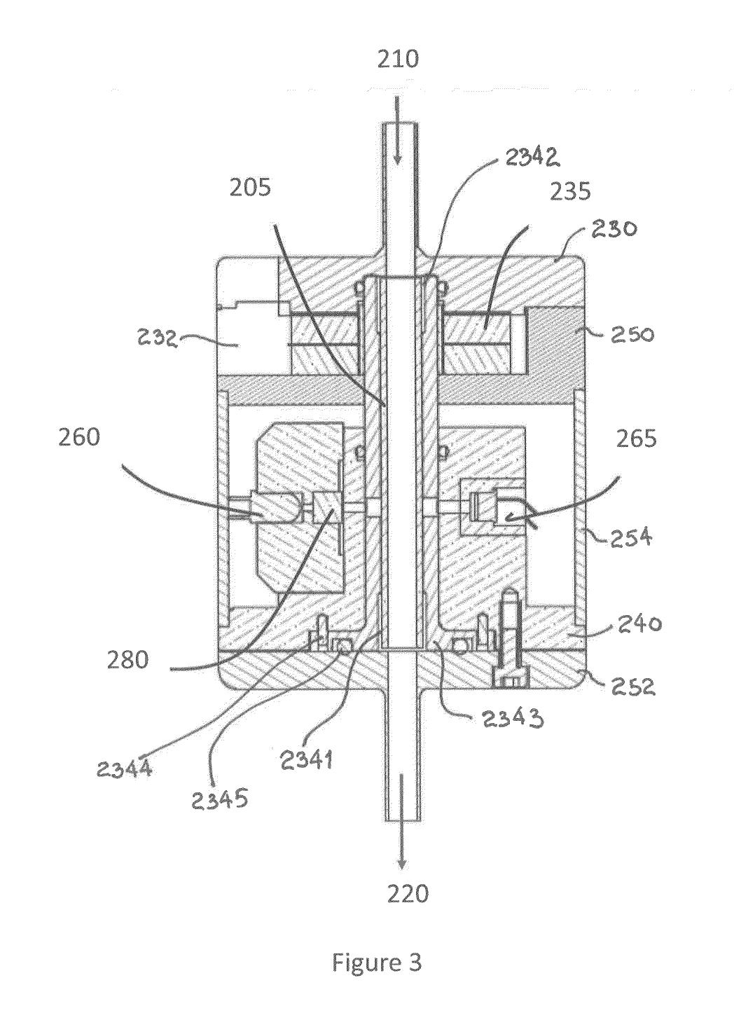

FIG. 3 is a front elevation, cross-sectional view of an alternative to the powder flow monitor of FIG. 2. Comparing FIG. 3 to FIG. 2, it can be seen that the central, tubular extension 234 extends upwardly from the lower cover 252. Also, the tubular extension 234 is not integral with the lower cover 252 but comprises an annular flange 2343 connected to the cover 252 through screws such as 2344 and an O-ring 2345 for sealing. Accordingly, the annular piezoelectric actuators 235 are located at the distal end of the tubular extension 234 inside a cavity formed by top section 230 and middle plate 250.

As will be apparent to those of ordinary skill in the art, the powder flow monitors of FIGS. 2 and 3 can be turned upside down and/or the flow of powder in the tube 205 can be reversed. In FIG. 2, it may imply displacement of the feeder adapter cone 215 to the other end of the tube 205.

The powder flow monitor 200 is operably connected to a controller 270, for example an all-purpose computer or a specialized processor as shown in FIG. 2 that may be incorporated in the powder flow monitor 200 or otherwise dedicated to its control. The controller 270 is connected to the photodetector 265 and calculates the rate of flow of the powder, or any other feature of the flow of powder, as a function of a light intensity detected from the transparent tube 205 by the photodetector 265. In a variant, the controller 270 calculates a rate of flow of powder mass based on a correlation between the light intensity detected from the transparent tube 205 by the photodetector 265 and a known density of a material forming the powder particles. In an embodiment, the controller 270 may further control operation of the piezoelectric actuators 235 and of the light source 260. As can be appreciated assembly including the light source 260, the photodetector 265 and the controller 270 forms a sensor of the flow of powder in the tube 205.

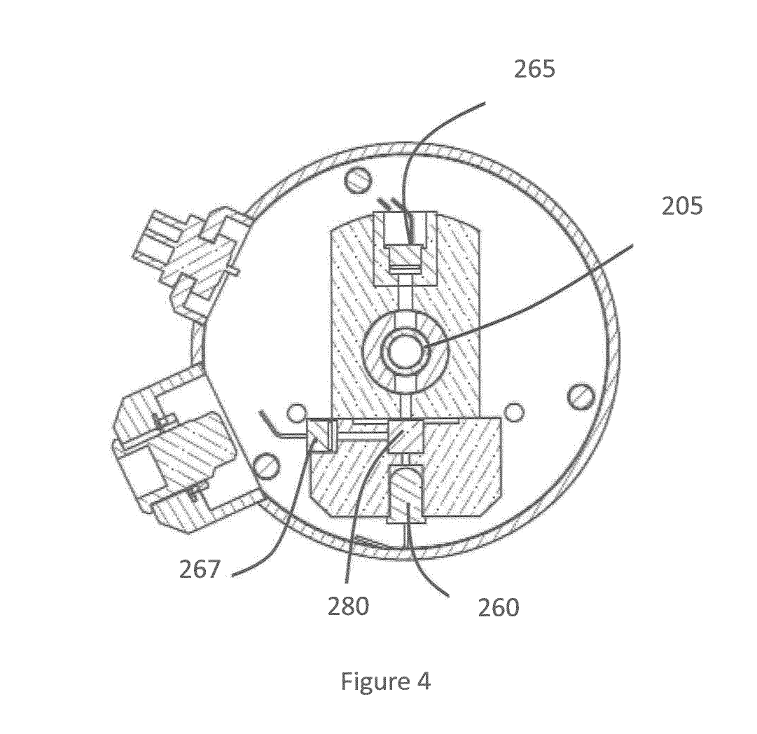

An alternate optical configuration of the light source 260 and photodetectors is shown in FIG. 4, which is a horizontal, cross-sectional view of a variant of the powder flow monitor having a pair of photodetectors. In this case the light source 260 may also be selected from a wide range of possibilities including, without limitation, a LED or a laser. A beam from the light source 260 passes through a beam splitter 280 which, as shown in FIG. 4, splits the beam into two substantially equal beams. One of these beams is channeled to the photodetector 265 after passing through the transparent powder transport tube 205 in a similar fashion as described in the setups of FIGS. 2 and 3. The second light beam emerging from the beam splitter 280 is channeled directly to a second photodetector 267 without passing through the transparent powder transport tube 205. The photodetector 267 acts as an auxiliary light sensor. A ratio of signal intensities measured by the photodetectors 265 and 267 and calculated by the controller 270 provides a direct function of the particle density in the powder transport tube 205 and is substantially independent of the intensity of light emitted by the light source 260. Such a configuration offers a more robust instrument that is less sensitive to variations of the intensity of light generated by the light source 260.

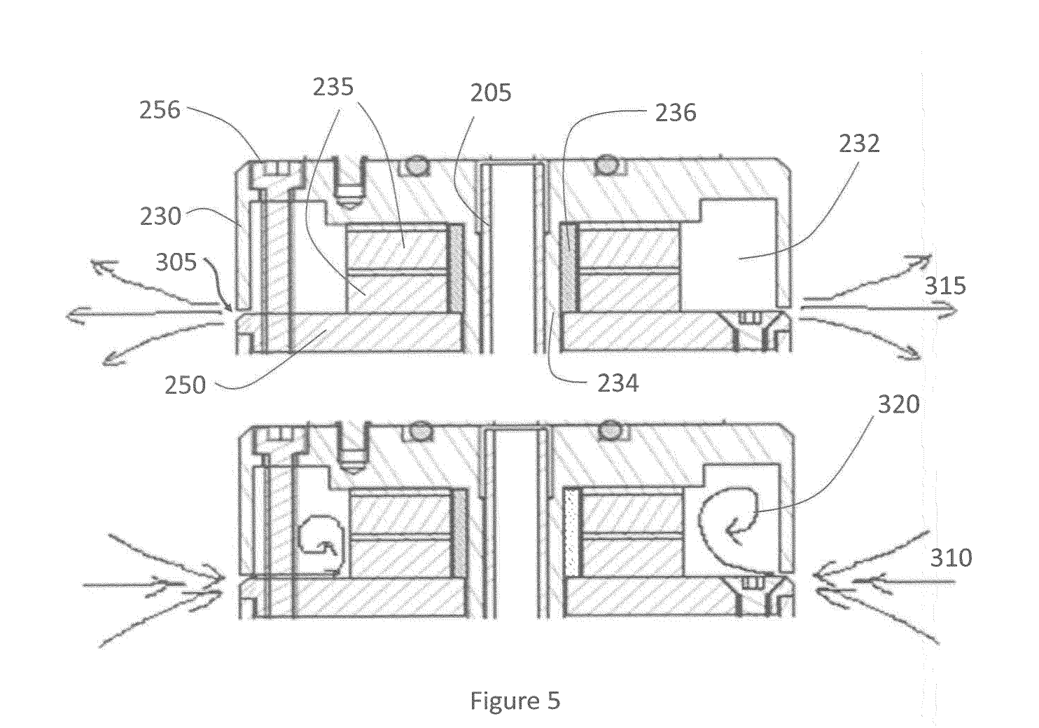

FIG. 5 schematically illustrates a system and method for cooling the piezoelectric actuators of the powder flow monitor of FIGS. 2-4. FIG. 5 shows a detailed view of the pair of annular piezoelectric actuators 235 placed in the annular cavity 232, around the insulating cylinder 236, around the tubular extension 234, and around the tube 205. A stack formed of a greater number of piezoelectric actuators 235 placed within the annular cavity 232 is also contemplated. A small gap 305 is provided between the top section 230 and the middle plate 250. Pulsation of the piezoelectric actuators 235 generates ambient air flows moving in 310 and out 315 of an empty portion of the annular cavity 232 around to the piezoelectric actuators 235. This creates a swirling effect 320 of air around the piezoelectric actuators 235 that provides cooling of the piezoelectric actuators 235 and stability of their performance.

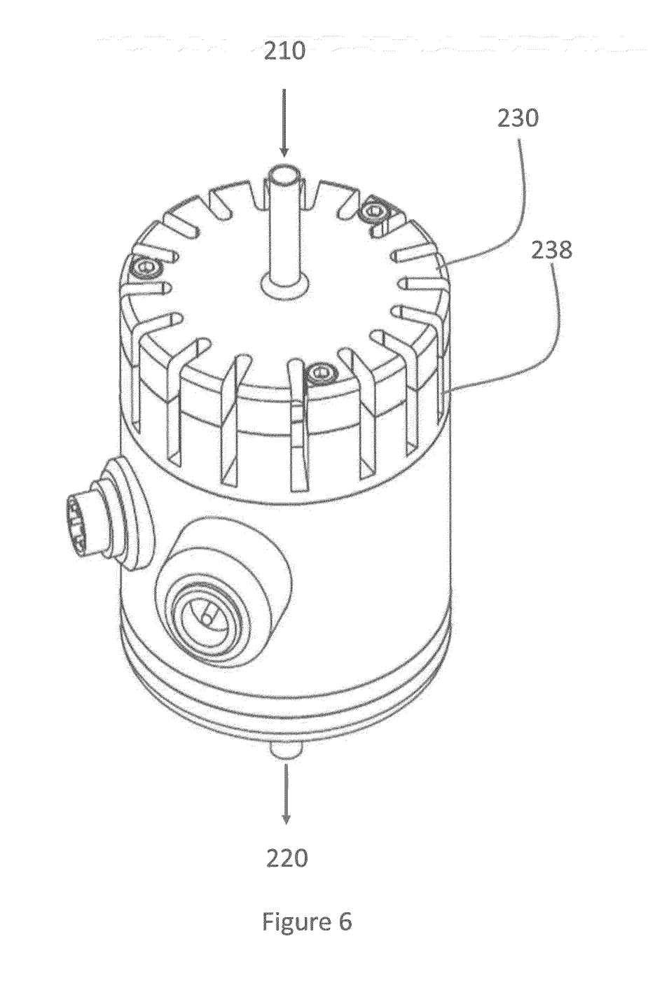

FIG. 6 is a perspective view of a variant of the powder flow monitor showing aeration grooves in a top section. In a variant, a plurality of openings, such as radial groves 238, are provided on the top section 230 in order to allow for a good level of cooling air circulation in a space surrounding the piezoelectric actuators 235. This optional arrangement provides an effective management of the heat generated by the piezoelectric actuators 235 and avoids excessive heating of the powder flow monitor 200 during continuous operation.

Though FIGS. 2 to 6 illustrate embodiments of the powder flow monitor using a light source and a light sensor to monitor a flow of powder, for example to evaluate a rate of flow of the powder, the present disclosure is not limited to use of light technology. Other powder flow monitoring technologies based on attenuation of sound waves in a fluid that carries powder particles, detection of variation of electrical properties of such a fluid, detection of variation of radio-activity transmittance of such a fluid, and the like, are also contemplated.

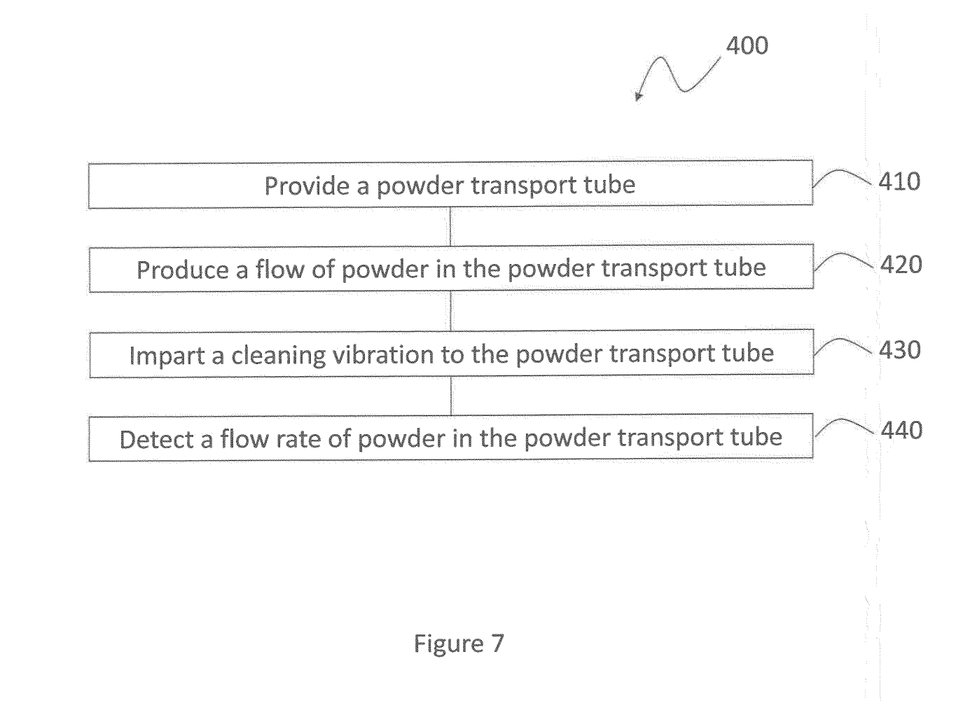

In yet another aspect, the present disclosure introduces a method for in-flight monitoring of a flow of powder. FIG. 7 is a sequence showing operations of a method for in-flight monitoring of a flow of powder according to an embodiment. A sequence 400 comprises operations that are not necessarily executed in the order as shown on FIG. 7. The sequence 400 comprises an operation 410 providing a powder transport tube. A flow of powder is produced in the powder transport tube in operation 420. Operation 430 comprises imparting a cleaning vibration to the powder transport tube, in particular to the inner surface of the powder transport tube. A feature of the flow of powder, for example a rate of flow of the powder in the powder transport tube is detected in operation 440.

Without limitation, the sequence 400 may be implemented in the powder flow monitor 200 of FIG. 2. Consequently, the powder transport tube may comprise a light-transparent powder transport tube 205 and detection of the rate of flow of powder in the powder transport tube may be effected by a light sensor such as the photodetector 265 detecting a fraction of light emitted by a light source 260, passing through the light-transparent powder transport tube 205 and not diffracted, scattered, or otherwise blocked by powder particles 140 in the powder transport tube 205. Likewise, without limitation, the cleaning vibration of the powder transport tube 205 may be applied by one or more piezoelectric actuators 235 generating a surface acoustic wave.

In one variant of the sequence 400, the cleaning vibration may be imparted continuously while detecting the feature of the flow of powder. Another variant may comprise manually triggering the cleaning vibration while detecting the feature of the flow of powder, for example when an operator detects that cleaning of the powder flow monitor may be required. A further variant may comprise imparting the cleaning vibration intermittently at regular intervals while detecting the feature of the flow of powder. This may for example be under the control of a controller for scheduling cleaning operations. Yet another variant may comprise triggering the cleaning vibration while detection of the feature of the flow of powder is stopped. Other manners of triggering the cleaning vibration, according to a variety of duty cycles, are contemplated.

### Typical Results

The powder flow monitor has been successfully tested with air and water as the transport fluid, and a wide range of powders of different materials and particle size distributions. Results given herein have been obtained using air as transport gas and spherical molybdenum (Mo) powder with particles size distribution in the range between 45 and 90 μm. These materials and values are provided for demonstration purpose without any limitation to the type of transport fluid whether gaseous or liquid, the solid material transported as powder and particle size range that can be used with such a device.

The tests involved operation of the powder flow monitor with different powder feed rates, over long periods, with stable powder transport conditions, and in the presence of periodic variation of the powder feed rate. A feeder having a rotating disc responsible for providing regular and variable feed rates was used. The tests also involved the continuous monitoring of the total mass of powder fed through the powder flow monitor over a given period of time. Powder was collected in a container placed on a laboratory balance with a universal serial bus (USB) signal output. The powder feed rate at any time was then computed as a variation of the weight as a function of time. In parallel, the instantaneous mass flow rate of the transported powder was measured using the powder flow monitor and the results displayed on the same graph.

Typical results from the tests are provided in FIGS. 5-8. On each of FIGS. 5-8, graphs show measures of light intensity, in arbitrary units (a.u.), on a left vertical axis, a cumulative weight of powder, in kilograms, on a first right vertical axis, and a powder mass flow rate, in grams per minute, on a second right vertical axis. Time, in seconds, is shown on a horizontal axis.

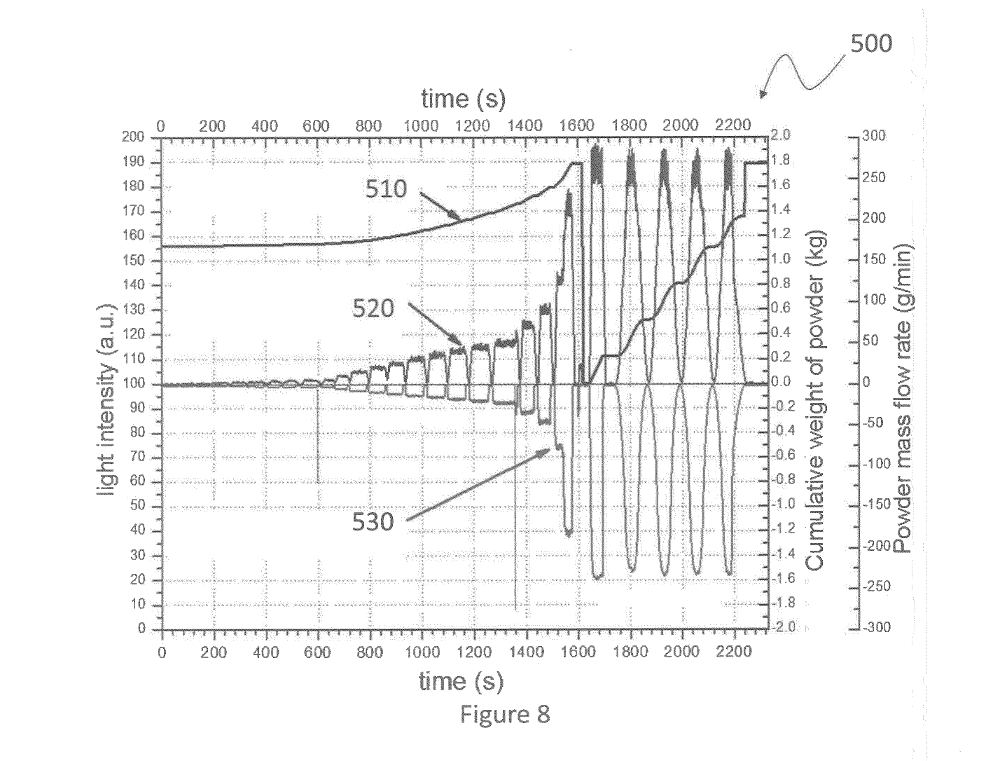

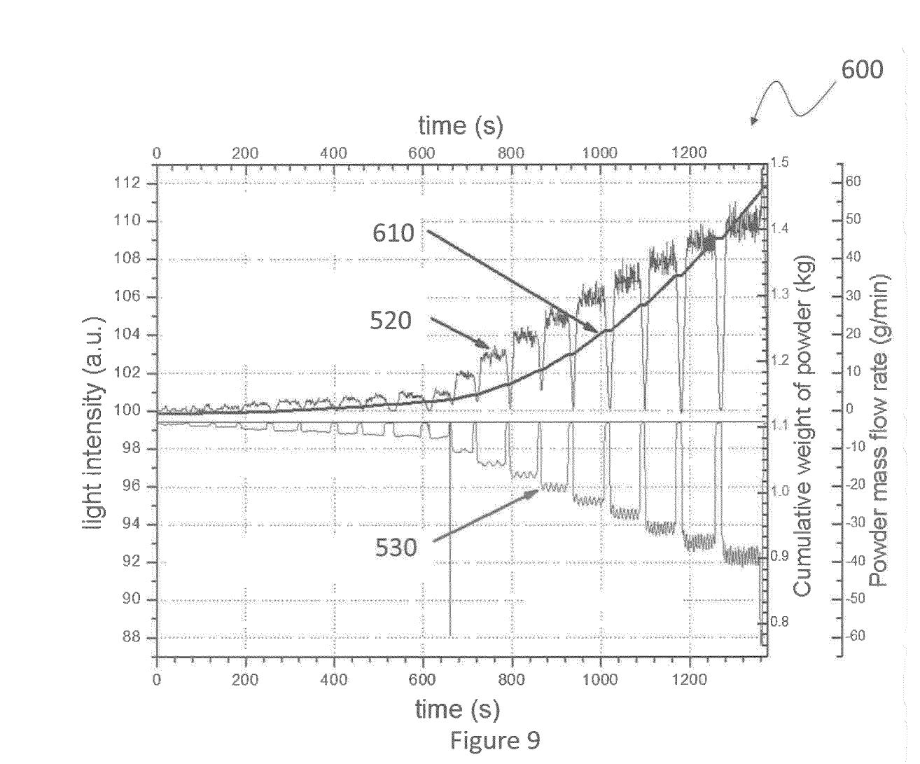

FIG. 8 is a graph showing powder flow measurements under various powder flow rates. The graph 500 shows a cumulative weight of powder curve 510, the weight being measured by a balance, a powder mass flow rate 520 calculated as a variation of the cumulative weight curve 510, and a light intensity measure 530 from the powder flow monitor 200. Initially on FIG. 8, the cumulative weight curve 510 has a value about 1.12 kg and the flow rate increases progressively, cycling between one-minute feed periods with increasing rates and short breaks during which verification is made that the powder mass flow rate 520 returns to zero and that the light intensity measure 530 returns to its maximum. The balance is emptied at about 1600 seconds and the test continues with feeding periods with a high flow rate and pauses. FIG. 9 is a graph showing details of the powder flow measurements of FIG. 8. A graph 600 reproduces results from the graph 500 of FIG. 8, highlighting first 1350 seconds thereof approximately. The cumulative weight curve 510 is tarred to offset the initial value of about 1.12 kg and is shown as a cumulative weight curve 610 of powder. The powder mass flow rate 520 and the light intensity measure 530 are reproduced. In both FIGS. 8 and 9, light intensity variations are inversely proportional to the powder mass flow rate. Correspondence between the measures obtained by the balance and the powder flow monitor 200 is excellent.

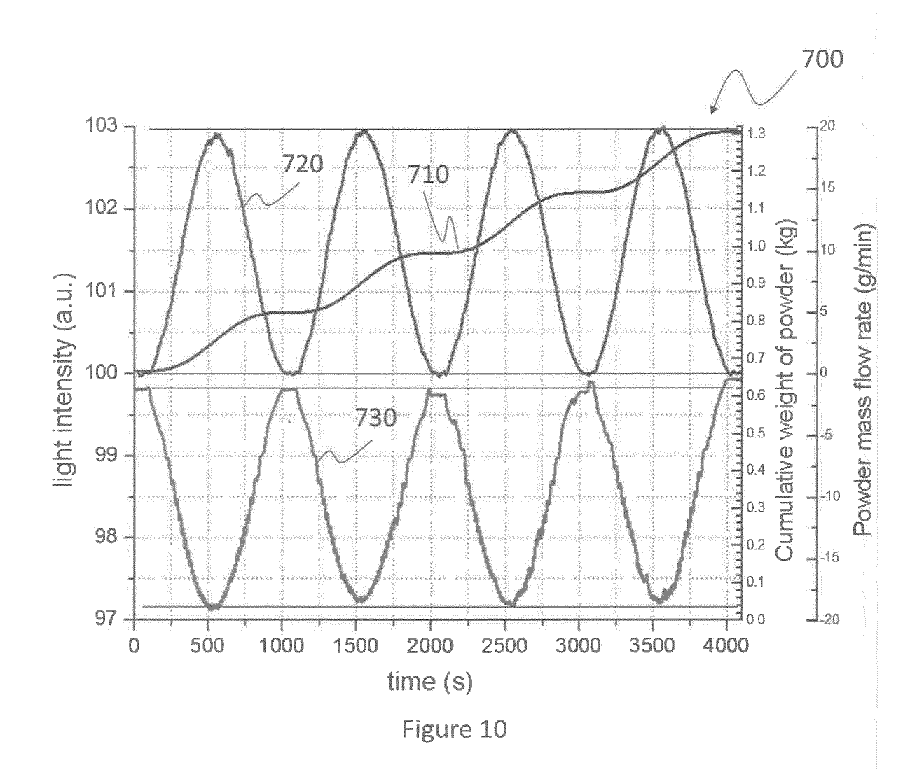

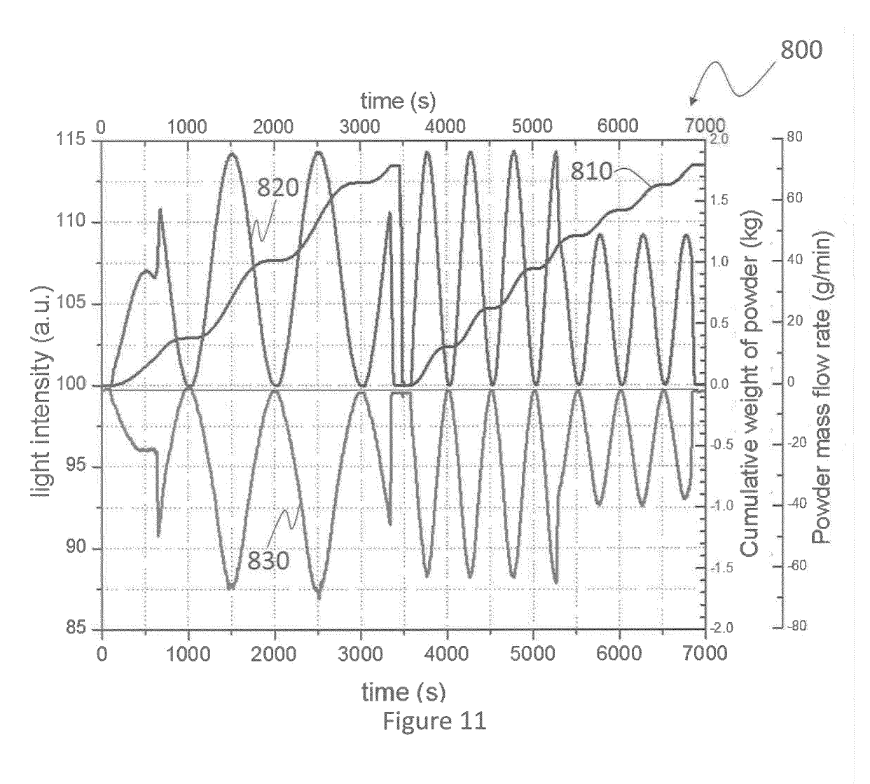

Further tests were carried out to determine the dynamic response of the powder flow monitor 200 through the modulation of the powder feed rate. FIG. 10 is a graph showing powder flow measurements using a powder feed rate modulated according to a sinusoidal signal. FIG. 10 shows a graph 700 in which a cumulative weight of powder curve 710, a powder mass flow rate 720 calculated as a variation of the cumulative weight curve 710, and a light intensity measure 730 from the powder flow monitor 200 are shown. FIG. 11 is graph showing powder flow measurements using a variable modulation of the powder feed rate. On FIG. 11, a graph 800 shows a cumulative weight of powder curve 810, a powder mass flow rate 820 calculated as a variation of the cumulative weight curve 810, and a light intensity measure 830 from the powder flow monitor 200. The balance is emptied at about 3500 seconds on FIG. 11. Results illustrated on FIGS. 10 and 11 show an excellent dynamic response of the powder flow monitor 200 over a broad frequency range of applied variations of the powder mass flow rate. It can be observed that the measurements provided by the powder flow monitor 200 are substantially without delay.

### Uses

The powder flow monitor of FIG. 2, and its variants, can be used for a plurality of applications. Without limitation, the powder flow monitor can be used for continuous monitoring of powder mass flow rate in pneumatic or hydraulic transport operations, for monitoring and quantitative measurement of a volume fraction of particles in a transport fluid, for the monitoring of powder loading of gaseous or liquid streams, for turbidity measurements in gaseous or liquid streams, or as an alarm for detecting irregularities or instabilities in pneumatic or hydraulic transport of powders.

Those of ordinary skill in the art will realize that the description of the powder flow monitor and method of in-flight monitoring of a flow of powder are illustrative only and are not intended to be in any way limiting. Other embodiments will readily suggest themselves to such persons with ordinary skill in the art having the benefit of the present disclosure. Furthermore, the disclosed powder flow monitor and method of in-flight monitoring of a flow of powder may be customized to offer valuable solutions to existing needs and problems of related to the determination of powder flows.

In the interest of clarity, not all of the routine features of the implementations of the powder flow monitor and method of in-flight monitoring of a flow of powder are shown and described. It will, of course, be appreciated that in the development of any such actual implementation of the powder flow monitor and method of in-flight monitoring of a flow of powder, numerous implementation-specific decisions may need to be made in order to achieve the developer's specific goals, such as compliance with application-, system-, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of powder flow measurements having the benefit of the present disclosure.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A powder flow monitor, comprising:
a powder transport tube;
a sensor of a flow of powder in the powder transport tube; and
an oscillator configured to impart a cleaning vibration to the powder transport tube.

2. The powder flow monitor of claim 1, wherein the powder flow sensor comprises:
a light source configured to illuminate powder particles suspended in fluid in the powder transport tube;
a light detector for sensing light emerging from the powder transport tube; and
a controller operably connected to the light detector and configured to calculate a feature of the flow of the powder as a function of a light intensity detected from the powder transport tube by the light detector.

3. The powder flow monitor of claim 2, wherein the powder transport tube is a light-transparent tube.

4. The powder flow monitor of claim 1, wherein the powder transport tube is made from a material that is immune to ultrasonic vibrations and to thermal charge generation.

5. The powder flow monitor of claim 2, wherein the light source comprises a source of white light.

6. The powder flow monitor of claim 2, wherein the light source comprises a light-emitting diode.

7. The powder flow monitor of claim 2, wherein the light source comprises a laser source.

8. The powder flow monitor of claim 2, wherein the light detector is selected from the group consisting of an optoelectronic photo-detector, a photo-resistor, a photodiode, and a solar battery.

9. The powder flow monitor of claim 2, wherein the controller calculates the feature of the flow of the powder based on a correlation between the light intensity detected from the powder transport tube by the light sensor and a known density of a material forming the powder particles.

10. The powder flow monitor of claim 2, wherein the light detector is a principal light detector, and wherein the powder flow monitor comprises an auxiliary light detector configured to detect a reference beam of light directly from the light source, the controller being further configured to calculate a particle density in the powder transport tube based on a ratio of the intensity of the light passing through the powder transport tube and detected by the principal light detector, to that of the reference light beam, which does not pass through the powder transport tube and is detected by the auxiliary light detector.

11. The powder flow monitor of claim 1, wherein the oscillator applies a surface acoustic wave to the powder transport tube.

12. The powder flow monitor of claim 1, wherein the oscillator is positioned at one end portion of the powder transport tube.

13. The powder flow monitor of claim 1, wherein the oscillator comprises at least one piezoelectric actuator.

14. The powder flow monitor of claim 13, comprising a pair of pulsating piezoelectric actuators configured to impart cooling air circulation.

15. The powder flow monitor of claim 13, comprising a stack of pulsating piezoelectric actuators configured to impart cooling air circulation.

16. The powder flow monitor of claim 1, comprising a casing including a plurality of openings providing air circulation for cooling the oscillator.

17. The powder flow monitor of claim 1, wherein the vibration is an ultrasonic vibration.

18. The powder flow monitor of claim 1, wherein the vibration causes homogenization of the flow of powder in the powder transport tube.

19. The powder flow monitor of claim 2, wherein the powder transport tube is made of non-transparent material and includes diametrically opposite windows to allow the passage of light through the powder transport tube.

20. The powder flow monitor of claim 2, wherein the powder transport tube is made of non-transparent material and includes diametrically opposite optical fibers to allow the passage of light through the powder transport tube.

21. The powder flow monitor of claim 1, comprising a casing portion with a tubular extension, wherein the powder transport tube is mounted within the tubular extension and wherein the oscillator is annular and positioned around the tubular extension to transmit vibrations to the powder transport tube through the tubular extension.

22. Use of the powder flow monitor of claim 1 for monitoring of powder mass flow rates in pneumatic or hydraulic transport operations.

23. Use of the powder flow monitor of claim 1 for measurement of a volume fraction of particles in a transport fluid.

24. Use of the powder flow monitor of claim 1 for detecting irregularities or instabilities in pneumatic or hydraulic transport of powders.

25. Use of the powder flow monitor of claim 1 for monitoring of powder loading of gaseous or liquid streams.

26. Use of the powder flow monitor of claim 1 for turbidity measurements in gaseous or liquid streams.

27. A method of in-flight monitoring of a flow of powder, comprising:
providing a powder transport tube;
producing the flow of powder in the powder transport tube;
detecting a feature of the flow of powder in the powder transport tube; and
imparting a cleaning vibration to the powder transport tube.

28. The method of claim 27, comprising continuously imparting the cleaning vibration while detecting the feature of the flow of powder.

29. The method of claim 27, comprising manually triggering the cleaning vibration while detecting the feature of the flow of powder.

30. The method of claim 27, comprising imparting the cleaning vibration intermittently at regular intervals while detecting the feature of the flow of powder.

31. The method of claim 27, comprising triggering the cleaning vibration while detection of the feature of the flow of powder is stopped.
